(19) United States
(12) Patent Application Publication
(10) Pub. No.: US 2009/0172557 A1
(43) Pub. Date: Jul. 2, 2009

(54) GUI SCREEN SHARING BETWEEN REAL PCS IN THE REAL WORLD AND VIRTUAL PCS IN THE VIRTUAL WORLD

(75) Inventor: Hidemasa Muta, Tokyo (JP)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/968,245

(22) Filed: Jan. 2, 2008

(51) Int. Cl. G06F 3/048

(52) U.S. Cl. 715/740; 715/733

(57) ABSTRACT

A computer program product stored on machine readable media including machine executable instructions for sharing a graphical user interface (GUI) between a physical computer and a computer defined in software, includes instructions for: pasting a replicated image of the GUI from the physical computer into a representation of a display of the computer defined in software. A system and another computer program product are provided.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

The invention herein relates to management of computer display information and in particular, to sharing of display information between actual as well as virtual computers.

2. Description of the Related Art

An avatar-based three-dimensional virtual world, as seen in Second Life, attracts much attention. A variety of enterprises, groups, educational institutions, etc., try to enter such virtual worlds. Needs are increasing for multiple avatars to develop communication in the virtual world in the same way as in the real world, so as to hold a seminar and have a business talk in the virtual world (for example) and to share information effectively. However, at present, to make a presentation inside a virtual world, it is necessary to upload images used in the explanation to the virtual world management server in advance. In order for such content to appear as three-dimensional objects in the virtual world, expert knowledge of some degree is required.

On the other hand, in the real world, for a presentation in a location where people gather, visual explanations are usually given using explanatory documents that are easily prepared with presentation tools such as Microsoft PowerPoint. Further, of late, it has become possible to use GUI screen-sharing tools (such as Lotus Sametime and Microsoft NetMeeting) to participate in a seminar/meeting from a remote site while sharing a presentation screen.

What are needed are facilities for managing and sharing display information in at least one of the real world and the virtual world.

### SUMMARY OF THE INVENTION

The shortcomings of the prior art are overcome and additional advantages are provided through the provision of a computer program product stored on machine readable media and including machine executable instructions for sharing a graphical user interface (GUI) between a physical computer and a computer defined in software, the product including instructions for: pasting a replicated image of the GUI from the physical computer into a representation of a display of the computer defined in software.

In addition, a system for providing a physical display and an electronic representation of a display is provided and includes: a processing system for executing machine executable instructions; and a computer program product stored on machine readable media and including machine executable instructions for sharing a graphical user interface (GUI) between the physical display and a display defined in software, the product including instructions for: pasting a replicated image of the GUI from the physical display into a representation of the display of the computer defined in software.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which a computer program product stored on machine readable media provides machine executable instructions for sharing a graphical user interface (GUI) between a physical computer and a computer defined in software, the product including instructions for: pasting a replicated image of the GUI from the physical computer into a representation of a display of the computer defined in software; locating an arrow-type object in the computer defined in software; synchronizing a change in the GUI of the physical computer with the GUI of the computer defined in software; remotely controlling the computer defined in software; and at least one of: calculating differences between displays; obtaining drawing information; determining a difference drawing; streaming video; receiving input and generating output for at least one of the physical computer and the computer defined in software; wherein the physical computer defines a real world computer and the computer defined in software defines a virtual world computer.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a processing system for practice of the teachings herein;

FIG. 2 illustrates one example of an implementation for sharing of a graphical user interface (GUI);

FIG. 3 illustrates another example of an implementation for sharing of a graphical user interface (GUI);

FIG. 4 illustrates aspects of a method for synchronization of a pointing event;

FIG. 5 illustrates aspects of a method for synchronization of a key input event;

FIG. 6 illustrates one example of implementation by a visible remote control client application;

FIG. 7 illustrates one example of implementation by an invisible remote control client application;

FIG. 8 illustrates one example of target IP address notification by use of a bar code; and

FIG. 9 illustrates providing multiple GUI sessions.

The detailed description explains the preferred embodiments of the invention, together with advantages and features, by way of example with reference to the drawings.

### DETAILED DESCRIPTION OF THE INVENTION

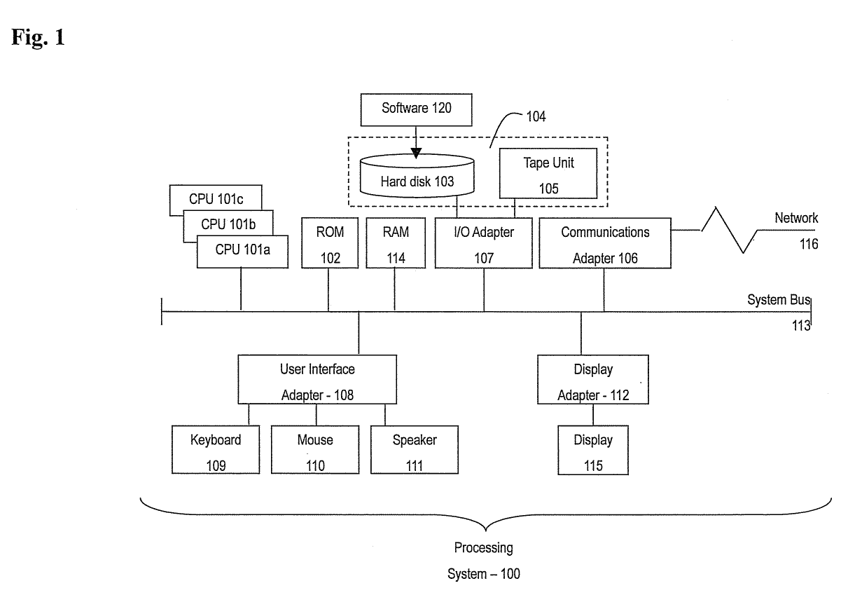

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Thus, as configured in FIG. 1, the system 100 includes processing means in the form of processors 101, storage means including system memory 114 and mass storage 104, input means such as keyboard 109 and mouse 110, and output means including speaker 111 and display 115. In one embodiment, a portion of system memory 114 and mass storage 104 collectively store an operating system such as the AIX® operating system from IBM Corporation to coordinate the functions of the various components shown in FIG. 1.

It will be appreciated that the system 100 can be any suitable computer or computing platform, and may include a terminal, wireless device, information appliance, device, workstation, mini-computer, mainframe computer, personal digital assistant (PDA) or other computing device.

Examples of operating systems that may be supported by the system 100 include Windows 95, Windows 98, Windows NT 4.0, Windows XP, Windows 2000, Windows CE, Windows Vista, Macintosh, Java, LINUX, and UNIX, or any other suitable operating system. The system 100 also includes a network interface 116 for communicating over a network. The network can be a local-area network (LAN), a metro-area network (MAN), or wide-area network (WAN), such as the Internet or World Wide Web.

Users of the system 100 can connect to the network through any suitable network interface 116 connection, such as standard telephone lines, digital subscriber line, LAN or WAN links (e.g., T1, T3), broadband connections (Frame Relay, ATM), and wireless connections (e.g., 802.11(a), 802.11(b), 802.11(g)).

As disclosed herein, the system 100 includes machine readable instructions stored on machine readable media (for example, the hard disk 104) for display of information shown on the screen 115 of a user. The display may be presented in at least one of the real world and the virtual world. As discussed herein, the instructions are referred to as “software” 120. The software 120 may be produced using software development tools as are known in the art. Also discussed herein, the software 120 may also referred to as a “display tool” 120, and “an interface” 120 or by other similar terms. The software 120 may include various tools and features for providing user interaction capabilities as are known in the art. Note that the software 120 provides functionality and features for other software used to create a “virtual world.” Accordingly, the term “software” generally refers to the teachings herein, while, in some instances, may make reference to other programs or code that interact with the software 120.

In some embodiments, the software 120 is provided as an overlay to another program. For example, the software 120 may be provided as an “add-in” to an application (or operating system). Note that the term “add-in” generally refers to supplemental program code as is known in the art. In such embodiments, the software 120 may replace structures or objects of the application or operating system with which it cooperates.

The software 120 may be native to (written to function within) computer application code programs (for example, C, C++, Perl, Java and others), other programs typically regarded as computing environments (UNIX, LINUX, DOS, and others) as well as other types of programs.

The teachings herein provide for depiction of a graphical user interface (GUI) of a processing system 100, such as a personal computer (PC), operating on an object in a virtual world. This is accomplished by, in one embodiment, pasting a replicated image of the GUI screen of the PC in a physical location or actual place (i.e., in the real world) on the surface of an object (screen of a PC, etc.) defined in software (i.e., an electronic replication or representation of a real world environment, referred to as a “virtual world”). Additionally, an arrow-type object may be located showing the position of a pointer at a pointing position, replacing it with an image used for texture mapping in synchronization with the change of the GUI screen in the real world, and moving the location of the arrow-type object according to any change in the pointing position.

Thus, one can perform a presentation using tools such as Microsoft PowerPoint, usually conducted in the real world, seamlessly in the virtual world. It is therefore possible to substantially reduce the time necessary for preparation and uploading of explanatory material. Further, explanatory material that once was difficult to express in the virtual world can now be provided with the same quality as in the real world, so that one can more effectively proceed with seminars and business meetings.

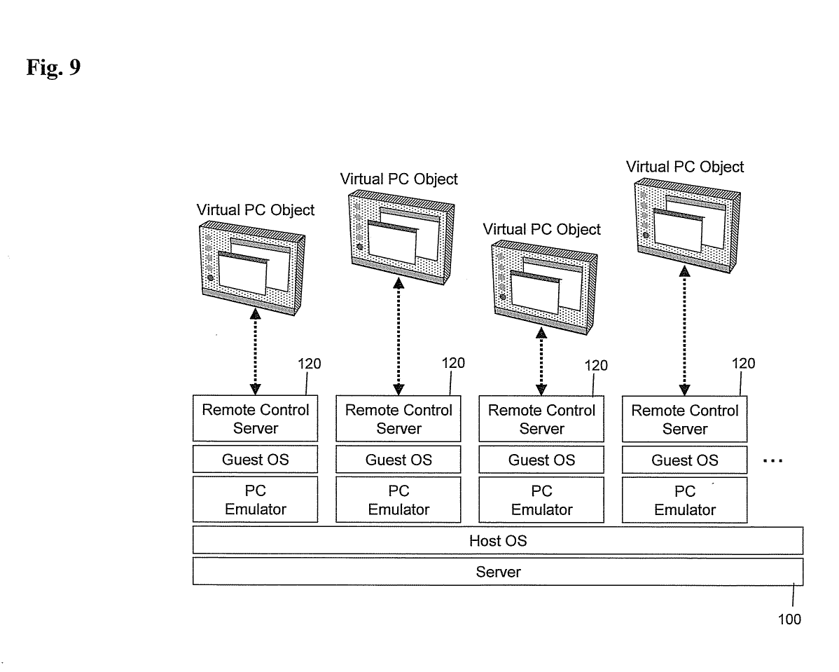

This invention is effective not only in the case of performing peer-to-peer remote control of a PC in the real world from a PC in the virtual world, but also in the case of performing remote control of an arbitrary GUI screen on a server (on which multiple GUIs are in operation) using a virtual PC execution environment such as VMWare, and performing remote control of invisible GUI sessions using CITRIX/Windows Terminal Server. Through combination with a server in the real world that is capable of providing multiple GUI sessions, a great number of virtual PC objects can be generated in a virtual world and operated in the same way as PCs in the real world, so that various applications (other than presentations) are also conceivable. (FIG. 9)

The teachings herein take advantage of two patents issued to the inventor of the present technology. Both of these patents are incorporated by reference in their entirety. A first patent is entitled “Remote controlling method a network server remote controlled by a terminal and a memory storage medium for HTML files” (U.S. Pat. No. 6,286,003). A second patent is entitled “Remote control method, server and recording medium” (U.S. Pat. No. 6,448,958).

In these patents, remote control is performed using such tools as web browsers, cellular phones, and PDAs so as to display the GUI screen of a PC at a remote site. In the present invention, among other things, an object defined in a virtual world is employed as a console for performing remote control.

To realize such an object in the virtual world, using an object behavior scripting language (Linden Script Language, in the case of Second Life) to describe the behavior of the object, communication is opened, for example, via http protocol between object behavior scripting code on the virtual world management server and a remote controlled application operating on a remote controlled PC in the real world, thereby transmitting and receiving GUI screen drawing information and input events.

Every time a difference is generated on the GUI screen of the remote controlled PC in the real world, the drawing information is transmitted to the object behavior scripting code on the virtual world management server and texture mapping is performed on the surface of the object, using an image where the difference is reflected. When an avatar performs actions such as pointer movements in the virtual world and pointer movements on a remote control PC in the real world, event information is transmitted to the remote controlled PC in the real world and the input event is reproduced thereon.

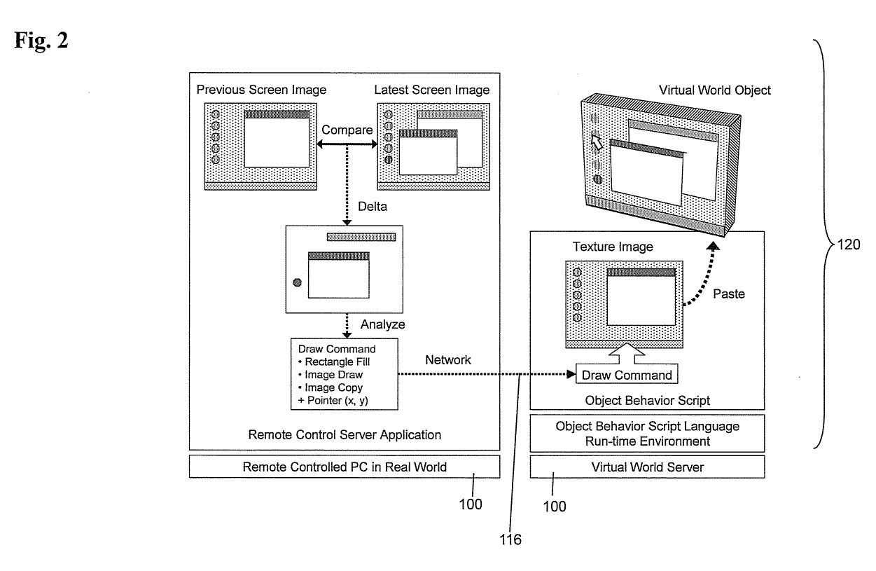

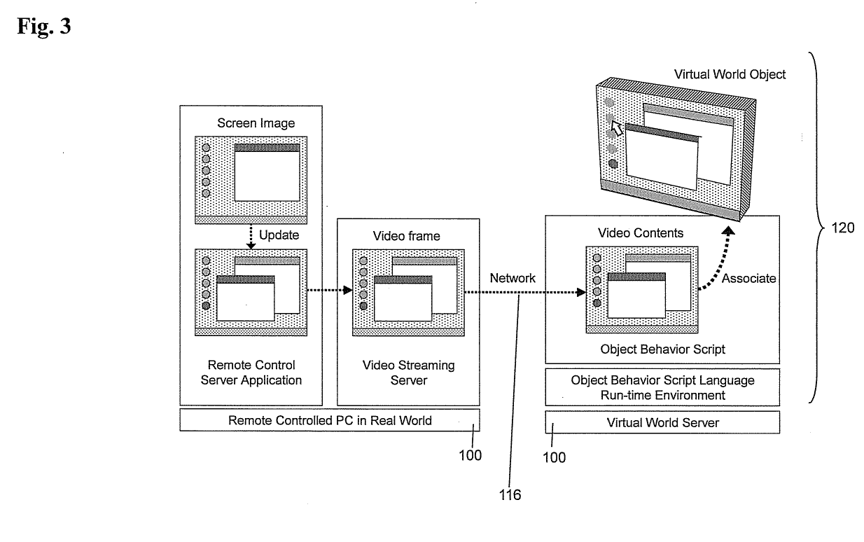

Two exemplary and non-limiting methods of implementation are disclosed herein and provide for sharing of the GUI screen. Reference may be had to FIGS. 2 and 3. In FIG. 2, a drawing command is generated from a difference on the screen image of the remote controlled PC in the real world, and by transmitting it to the object behavior scripting code on the virtual world management server. A difference drawing is conducted against the texture imaging to paste it on the surface of the object. Further, according to the change of the pointing position, the position of the arrow-type object is moved. As shown in FIG. 3, by associating the surface of the object with video contents in advance, when the screen of the remote controlled PC in the real world changes, it is received by a streaming distribution as video content to be pasted on the surface of the object. As for the packing method of FIG. 2, in addition to the method of calculating any difference in the screen image, there is also a method of obtaining drawing information from a drawing API by hooking the API level of a GUI drawing engine.

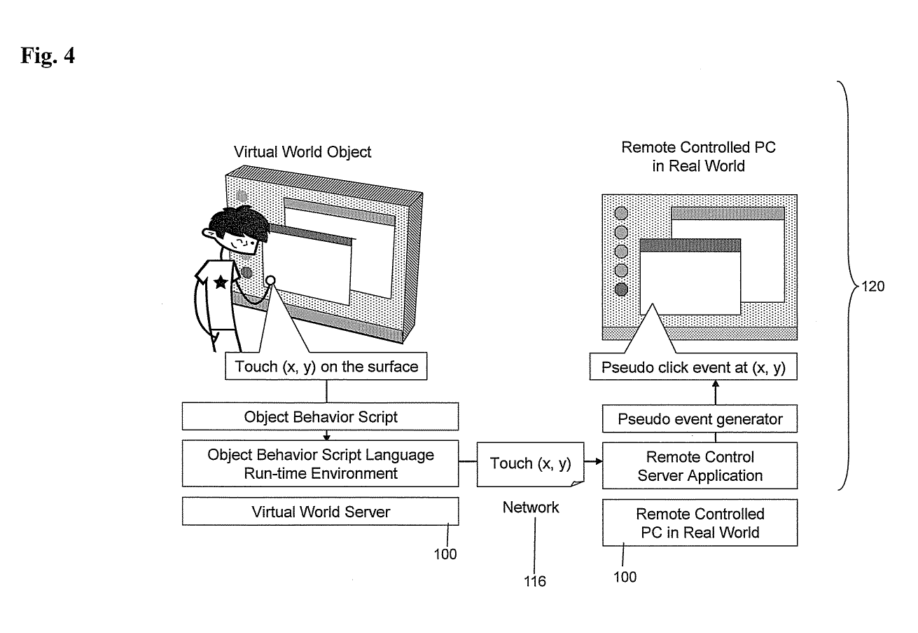

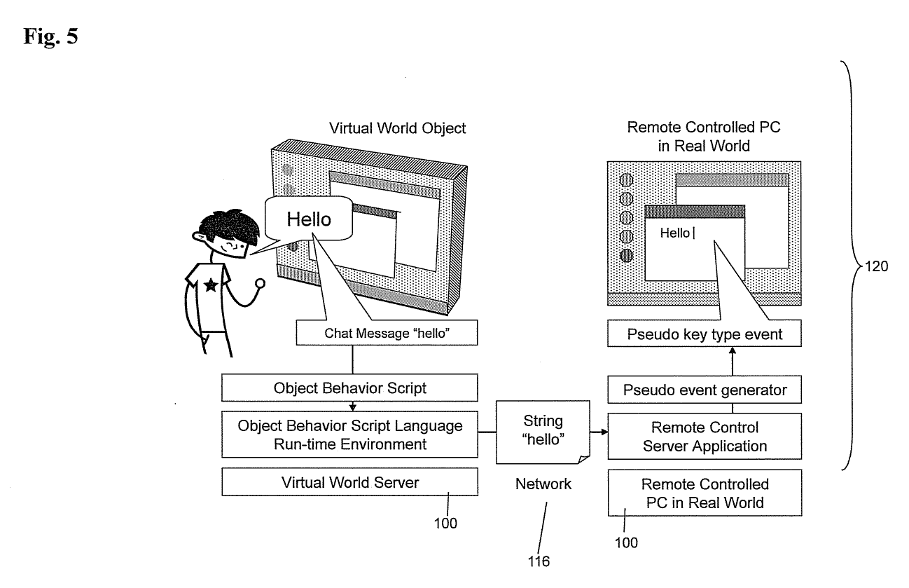

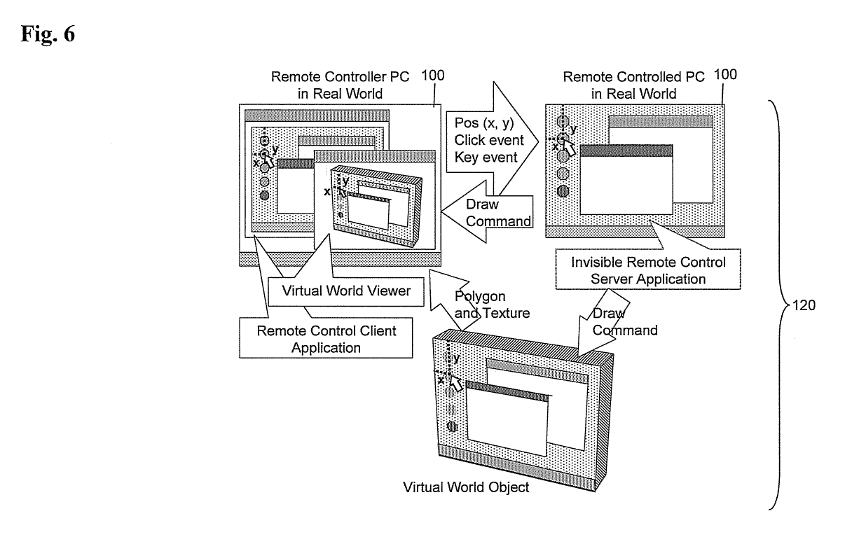

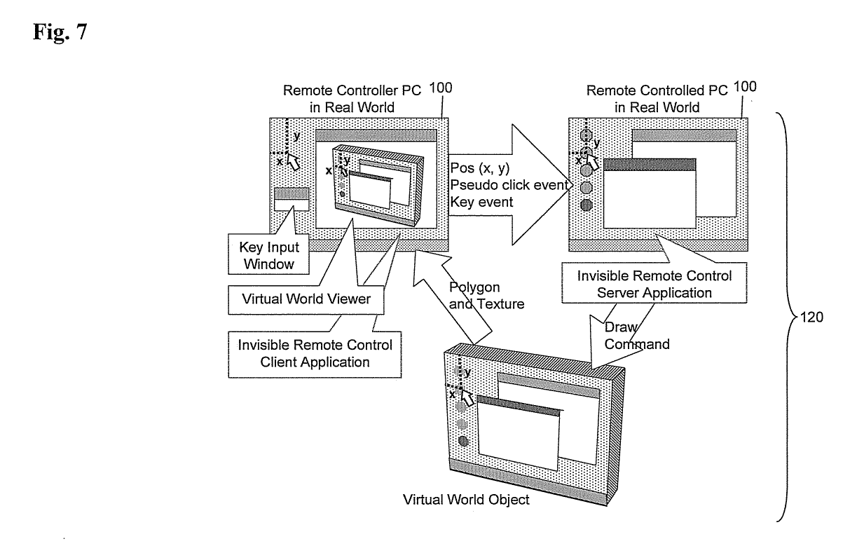

A description of the method of transmitting an input event to a remote controlled PC in the real world will be provided. Further provided are methods of generating the action of an avatar in a virtual world, as an input event source such as a pointer movement/key input, and methods of generation on a PC (hereinafter, referred to as a remote control PC in the real world) controlling the avatar in the real world. FIGS. 4 and 5 illustrate the former, and FIGS. 6 and 7 illustrate the latter.

FIG. 4 depicts aspects of an exemplary method of causing pointing system events, such as a mouse or touch panel, to be synchronized with the action of an avatar in a virtual world. When the avatar conducts a pointer movement, such as clicking against the surface of an object in the virtual world, the position information is transmitted to a PC in the real world, and based on the information a pseudo-event is created in a window system. Further, in FIG. 5, string information via chat input from the avatar at close range is transmitted to the PC in the real world so as to generate a pseudo key input event.

FIG. 6 shows a virtual world viewer expressing a virtual world on a remote control PC in the real world and, at the same time, circumstances of the operation of a remote control application displaying the GUI screen of a remote controlled PC in the real world. When performing pointer manipulation and key input on a remote control application, these input events are delivered to the remote controlled PC in the real world to be reproduced. Moreover, information such as pointer position is also delivered to objects in the virtual world, and by the change of position of the arrow-type object on the surface of said object, the information is also reflected to the virtual world viewer on the remote control PC, which is the source of the event. Through a series of these operations, when performing a two-dimensional pointing operation of the remote control application on a remote control PC in the real world, it is reproduced as a three-dimensional pointing operation in the virtual world viewer. FIG. 7 shows its development; that is, the remote control application is made invisible. By making the application invisible, no transmission of drawing information of the GUI screen is required from a remote controlled PC in the real world, so the pointing operation is conducted while looking only at the virtual world viewer. As an example of a pointing coordinate system, when performing a two-dimensional pointing operation in the coordinate system (in which the whole desktop screen of a remote control PC in the real world corresponds with the screen of a remote controlled PC in the real world) it is reproduced by the virtual world viewer as a three-dimensional pointing operation. As for click operation, since when actually clicking, the click event is reflected on the desktop of the remote control PC, pseudo click operation is conducted using the SHIFT key and Alt key as substitutes for the mouse button. With regard to key input, methods are conceivable in which input to the remote control PC and input to the remote controlled PC is switched by a mode change, and input to the remote controlled PC is conducted by providing a window exclusively used for key input and focusing thereon.

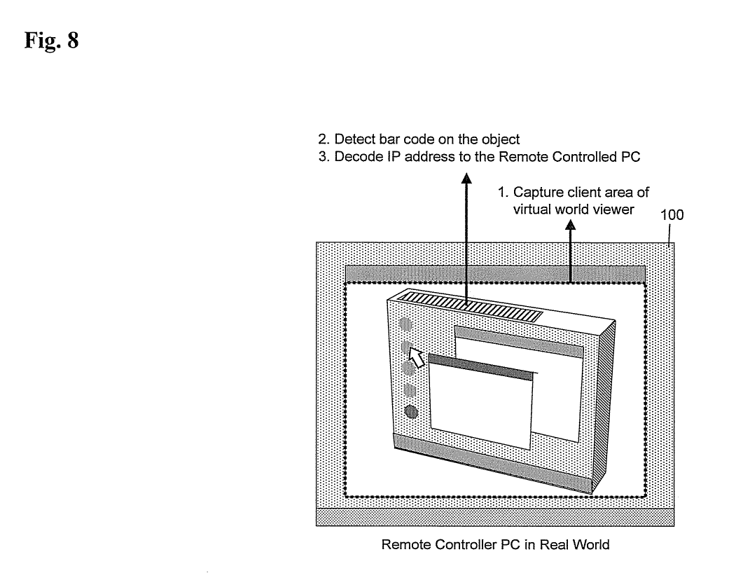

FIG. 8 is an example of a method of delivering the IP address of a remote controlled PC to a remote control application on a remote control PC in the real world. When a virtual object reproducing the GUI screen of a remote controlled PC is displayed on the virtual world viewer, texture expressing patterns (such as barcodes) is pasted on a part of it (in FIG. 8, an upper surface of the object), and through screen capturing and analysis of the client area of the virtual world viewer by the remote control application (with such virtual objects displayed) the barcode area can be detected and decoded. In the barcode, the IP address of the remote controlled PC is recorded, and based on it, it is possible to establish a connection with the remote controlled PC to conduct the subsequent remote control. In addition, such a mechanism is not necessary when the virtual world viewer can be freely modified. However, a method of receiving the IP address of a remote controlled PC as meta data of a virtual world object, delivering it to the remote control application as a window message, and a method of integrating the virtual world viewer and remote control application, are conceivable.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer program product stored on machine readable media and comprising machine executable instructions for sharing a graphical user interface (GUI) between a physical computer and a computer defined in software, the product comprising instructions for:
pasting a replicated image of the GUI from the physical computer into a representation of a display of the computer defined in software.

2. The computer program product as in claim 1, further comprising instructions for locating an arrow-type object in the computer defined in software.

3. The computer program product as in claim 1, further comprising instructions for synchronizing a change in the GUI of the physical computer with the GUI of the computer defined in software.

4. The computer program product as in claim 1, further comprising instructions for remote control of the computer defined in software.

5. The computer program product as in claim 1, wherein the physical computer defines a real world computer

6. The computer program product as in claim 1, wherein the computer defined in software defines a virtual world computer.

7. The computer program product as in claim 1, further comprising instructions for at least one of: calculating differences between displays; obtaining drawing information; determining a difference drawing; streaming video; pointer movement; receiving input and generating output for at least one of the physical computer and the computer defined in software.

8. The computer program product as in claim 1, wherein the representation is at least one of machine readable instructions and a graphical object.

9. A system for providing a physical display and an electronic representation of a display, the system comprising:
a processing system for executing machine executable instructions; and
a computer program product stored on machine readable media and comprising machine executable instructions for sharing a graphical user interface (GUI) between the physical display and a display defined in software, the product comprising instructions for: pasting a replicated image of the GUI from the physical display into a representation of the display of the computer defined in software.

10. The system as in claim 9, comprising at least one of a server, a processor, and a network.

11. A computer program product stored on machine readable media and comprising machine executable instructions for sharing a graphical user interface (GUI) between a physical computer and a computer defined in software, the product comprising instructions for:
pasting a replicated image of the GUI from the physical computer into a representation of a display of the computer defined in software;
locating an arrow-type object in the computer defined in software;
synchronizing a change in the GUI of the physical computer with the GUI of the computer defined in software;
synchronizing a change of pointer position of the physical computer with the pointer position of the computer defined in software;
remotely controlling the computer defined in software; and
at least one of: calculating differences between displays; obtaining drawing information; determining a difference drawing; streaming video; pointer movement; receiving input and generating output for at least one of the physical computer and the computer defined in software;
wherein the physical computer defines a real world computer and the computer defined in software defines a virtual world computer.
